(19) United States
(12) Patent Application Publication
(10) Pub. No.: US 2003/0173424 A1
(43) Pub. Date: Sep. 18, 2003

(54) Fuel injection valve

(76) Inventors: Guenter Dentes, Eberdingen (DE); Detlef Nowak, Untergruppenbach (DE); Matthias Waldau, Pforzheim (DE)

Correspondence Address: KENYON & KENYON, ONE BROADWAY, NEW YORK, NY, 10004, US

(21) Appl. No.: 10/130,575

(22) PCT Filed: Aug. 25, 2001
(86) PCT No.: PCT/DE01/03259

(30) Foreign Application Priority Data
Sep. 19, 2000 (DE) 10046306.1

(51) Int. Cl. F02M 59/00

(52) U.S. Cl. 239/533.2

(57) ABSTRACT

A fuel injector (1), in particular for direct injection of fuel into a combustion chamber of an internal combustion engine, having a valve-closure member (4) which, together with a valve-seat surface (6) constructed on a valve-seat member (5), forms a sealing seat, and having a swirl disk (34) having fuel passages (35), the swirl disk (34) being constructed from a plurality of swirl elements (36), each of the swirl elements having the same number of fuel passages (35). The swirl elements (36) are offset with respect to one another in such a way that the fuel passages (35) at least partially overlap.

### BACKGROUND INFORMATION

The present invention is based on to a fuel injector according to the preamble of the main claim.

A fuel injector is known from German Patent Application 197 36 682 A1 which is characterized by the fact that on the downstream end of the valve a guide and seating area is provided which is formed from three disk-shaped elements. A swirl element is imbedded between a guide element and a valve seat element. The guide element guides an axially movable valve needle projecting through it, while a valve closing section of the valve needle cooperates with a valve-seat surface of the valve seat element. The swirl element has an inner opening area containing a plurality of swirl channels which are not connected to the outer periphery of the swirl element. The entire opening area extends completely over the axial depth of the swirl element.

In addition, a fuel injector is known from German Patent Application 198 15 789 A1 which is characterized by the fact that the fuel injector has a swirl disk located downstream from a valve seat, the swirl disk including at least one metallic material and having at least two swirl channels which open into a swirl chamber, all the layers of the swirl disk being adhesively deposited one directly on top of the other by electrodeposition (multilayer metallization). The swirl disk is installed in the valve in such a way that its surface normal runs diagonally to the longitudinal axis of the valve at an angle deviating from 0°, so that a jet angle γ with respect to the longitudinal axis of the valve is obtained by aligning the swirl disk.

A particular disadvantage of the fuel injectors known from the aforementioned documents is the high cost associated with the complicated manufacturing requirements. Modifying the fuel injector for a desired use requires the use of complicated manufacturing procedures. In particular, jet angles α and γ cannot be achieved using common swirl generation methods.

### ADVANTAGES OF THE INVENTION

The fuel injector according to the present invention having the characterizing features of the main claim has the advantage over the related art that a swirl disk having individual swirl elements is easily manufacturable and may be used in any standard fuel injectors. The number of swirl elements as well as the number of overlapping fuel passages forming fuel channels which impart swirl on the fuel may be varied as desired, and may be easily adapted according to the demands on the fuel injector.

Advantageous refinements of the fuel injector characterized in the main claim are possible through the measures characterized in the subclaims.

It is also advantageous that the swirl disk may be situated either on the inflow side or on the outflow side of the sealing seat, depending on the construction of the fuel injector.

In addition, an inclination of the longitudinal axis of the valve-seat member with respect to the longitudinal axis of the fuel injector is advantageous for use in inclined injection.

It is advantageous to construct on the outflow side of the swirl disk a swirl chamber which is dimensioned in such a way that a homogeneous swirl flow may be formed in it.

It is advantageous to arrange the swirl disk in a plug-in unit which is insertable into the valve-seat member, since the plug-in unit and the cavity which accommodates it are easily manufacturable.

### DRAWING

Embodiments of the present invention are illustrated in simplified form in the drawing and explained in greater detail in the following description.

FIG. 1 shows a schematic partial section through a first embodiment of a fuel injector according to the present invention,

FIG. 2A shows a schematic partial section of the first embodiment of the fuel injector according to the present invention illustrated in FIG. 1, in region II of FIG. 1,

FIG. 2B shows a schematic top view of the swirl disk in FIG. 2A in the direction of outflow,

FIG. 3A shows a schematic partial section of a second embodiment of the fuel injector according to the present invention, in region II of FIG. 1, and

FIG. 3B shows a schematic top view of the swirl disk in FIG. 3A in the direction of outflow.

### DESCRIPTION OF THE EXEMPLARY EMBODIMENTS

Fuel injector 1 is designed in the form of a fuel injector 1 for fuel injection systems of internal combustion engines having compression of a fuel/air mixture with spark ignition. Fuel injector 1 is suitable in particular for direct injection of fuel into a combustion chamber (not shown) of an internal combustion engine.

Fuel injector 1 has a nozzle body 2 in which a valve needle 3 is situated. Valve needle 3 is mechanically linked to a valve-closure member 4 which cooperates with a valve-seat surface 6 situated on a valve-seat member 5 to form a sealing seat. Valve-seat member 5 is insertable into a cavity 50 of nozzle body 2. In this embodiment, fuel injector 1 is an inwardly opening fuel injector 1 having an spray-discharge orifice 7. Nozzle body 2 is sealed by a gasket 8 with respect to a stationary pole 9 of a solenoid 10. Solenoid 10 is encapsulated in a coil casing 11 and is wound onto a field frame 12, which is in contact with an internal pole 13 of solenoid 10. Internal pole 13 and stationary pole 9 are separated by a gap 26 and are supported on a connecting component 29. Solenoid 10 is energized by an electric current supplied via an electric plug-in contact 17 over a line 19. Plug-in contact 17 is enclosed in plastic sheathing 18 which may be extruded onto internal pole 13.

Valve needle 3 is guided in a valve needle guide 14, which is designed in the form of a disk. A matching adjusting disk 15 is used to adjust the lift. An armature 20 is situated on the other side of adjusting disk 15. The armature is in friction-locked connection to valve needle 3 via a first flange 21, the valve needle being connected to first flange 21 by a weld 22. A restoring spring 23 is supported on first flange 21 and is under prestress by a sleeve 24 in the present design of fuel injector 1.

A second flange 31, which is connected to valve needle 3 by a weld 33, is used as a lower armature stop. An elastic intermediate ring 32 which rests on second flange 31 prevents rebounding when fuel injector 1 is closed.

Fuel channels 30a and 30b run in valve needle guide 14 and in armature 20 and conduct the fuel, which is supplied through a central fuel feed 16 and filtered through a filter element 25, to spray-discharge orifice 7. Fuel injector 1 is sealed by a gasket 28 with respect to a fuel line (not shown).

On the inflow side of valve-seat member 5 is arranged a swirl disk 34, which in the present first embodiment is formed from four swirl elements 36a through 36d. Swirl elements 36 are welded to one another as well as to valve-seat member 5. Valve needle 3 passes through swirl disk 34, and is led through a cardanic valve needle guide 46 to avoid off-center displacement and tilting.

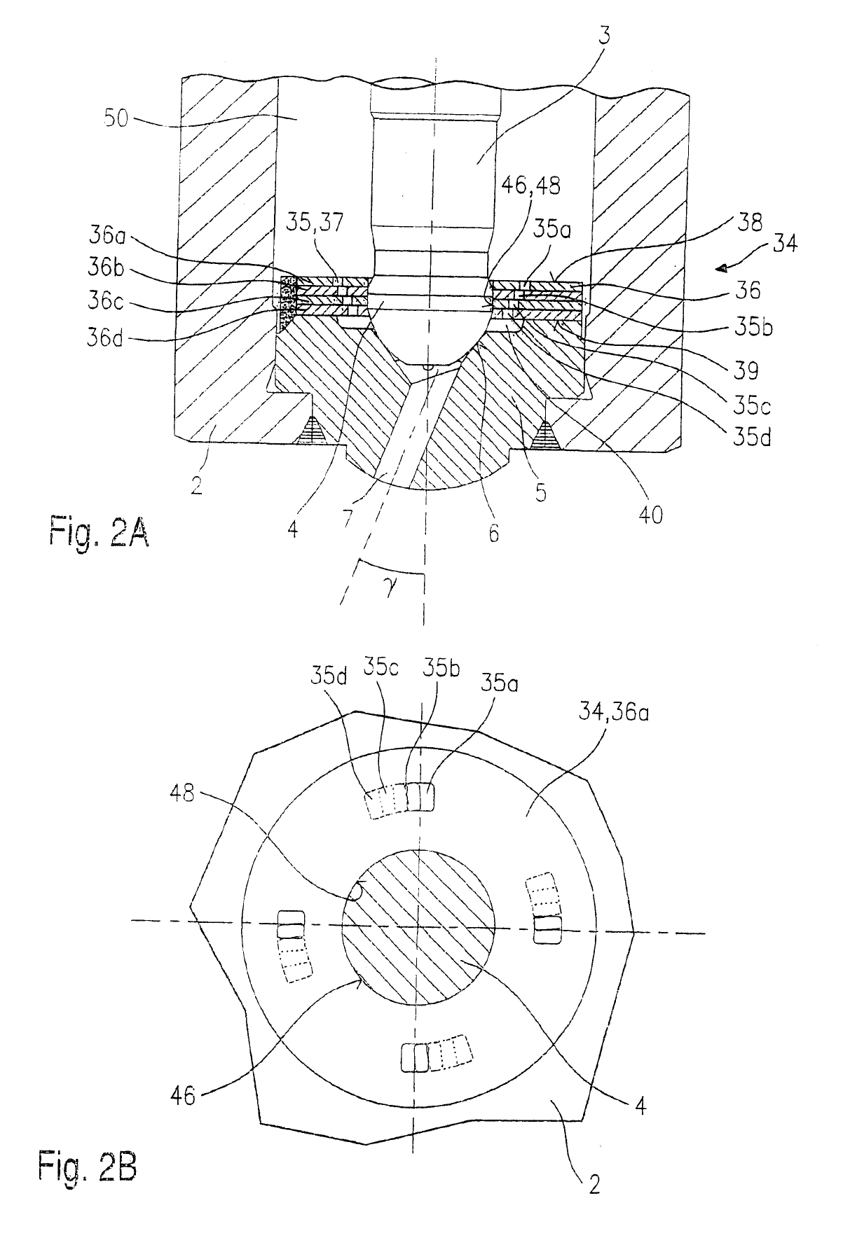

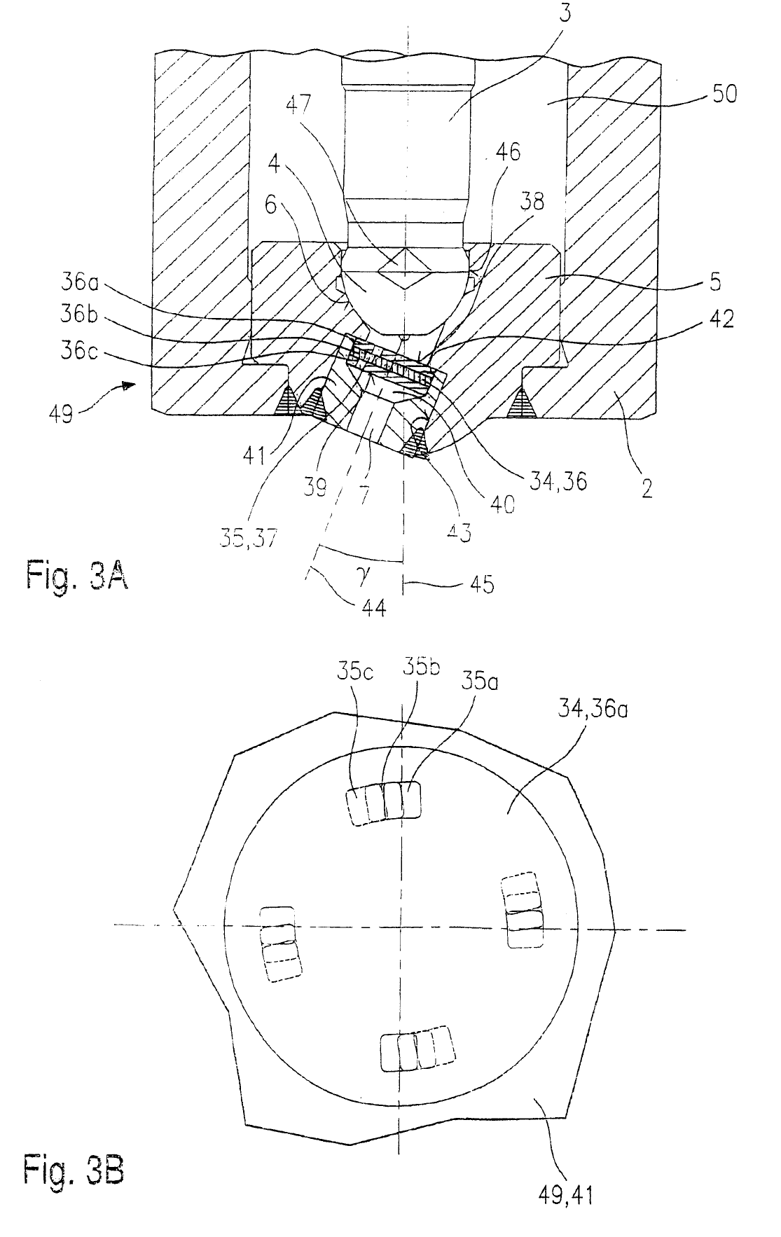

Swirl elements 36 of swirl disk 34 have fuel passages 35a through 35d which overlap to form fuel channels 37 which pass through swirl disk 34. A detailed representation of swirl elements 36 is shown in FIGS. 2 and 3.

In the resting state of fuel injector 1, armature 20 is acted upon by restoring spring 23 against its direction of lift in such a way that valve-closure member 4 is held in sealing contact with valve-seat surface 6. On energization of solenoid 10, it creates a magnetic field which moves armature 20 in the direction of lift against the spring force of restoring spring 23, the lift being predetermined by a working gap 27 which in the resting position is located between internal pole 12 and armature 20. Armature 20 entrains flange 21, which is welded to valve needle 3, also in the direction of lift. Valve-closure member 4, which is mechanically linked to valve needle 3, is lifted up from valve-seat surface 6, and the fuel is led via fuel channels 30a and 30b and via fuel channels 37 formed in swirl disk 34 to spray-discharge orifice 7, where it is injected. The spray-discharge orifice is preferably inclined at an injection angle γ with respect to a longitudinal axis 45 of fuel injector 1.

When the coil current is turned off, armature 20 drops back away from internal pole 13 after the magnetic field has decayed sufficiently, due to the pressure of restoring spring 23, so that flange 21, which is mechanically linked to valve needle 3, moves in the direction opposite the direction of lift. Valve needle 3 is thereby moved in the same direction, so that valve-closure member 4 is set down on valve-seat surface 6 and fuel injector 1 is closed.

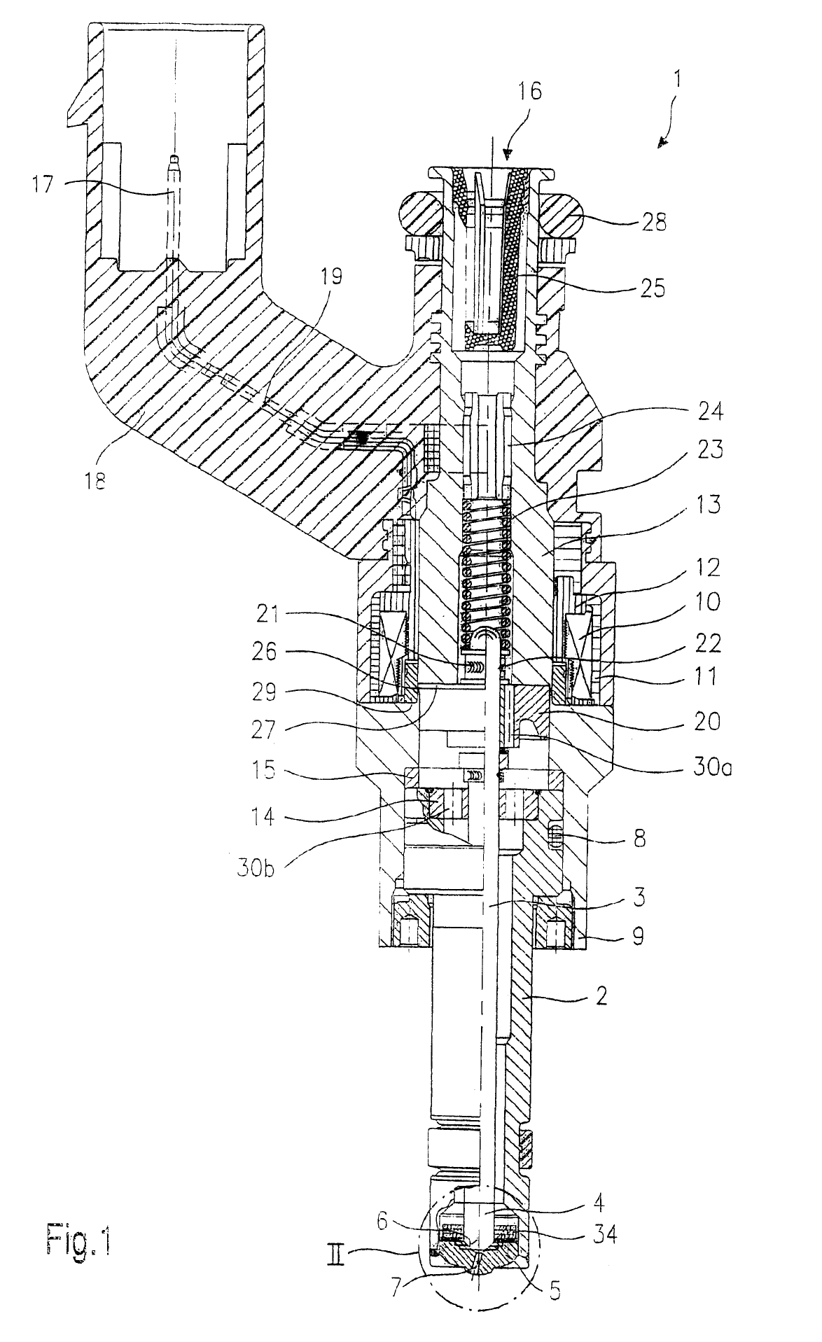

FIG. 2A shows in sectional representation an enlarged view of the injection-side portion of the first embodiment of a fuel injector 1 according to the present invention described in FIG. 1. The shown section is denoted by II in FIG. 1.

Swirl disk 34, which in the present embodiment is constructed from four swirl elements 36, is inserted into a central cavity 47 in fuel injector 1 and rests on valve-seat member 5. To protect against displacement or lifting up when fuel injector 1 is actuated, the four swirl elements 36 are preferably welded or soldered to one another as well as to valve-seat member 5. However, swirl elements 36 may also be formed in multiple layers by electrodeposition methods.

The four swirl elements 36 each have the same number of fuel passages 35. In the present embodiment, four fuel passages 35a through 35d are illustrated. However, the number of fuel passages may be increased if desired, taking stability and flow maintenance criteria into consideration. Fuel passages 35 may be produced by erosion, punching, etching, drilling, or similar methods. To form a turbulence-producing fuel channel 37 which extends from a side 38 on the inflow side of swirl disk 34 to a side 39 on the outflow side of swirl disk 34, fuel passages 35 are offset with respect to one another so that they at least partially overlap. The displacements in individual swirl elements 36 must be produced in the same direction. To produce turbulence, the fuel passages must be offset axially, but they may also have a radial offset component. Swirl disk 34 may be connected to nozzle body 2 or to valve-seat member 5 by soldering, welding, or also by caulking, press-fitting, or similar methods.

The cross section of fuel passages 35 may have a square design with rounded corners, as in the present embodiment. As shown in FIG. 2B, however, the cross section may also take on any other shapes. For example, fuel passages 35 may have a round or oblong cross section. Rounded shapes have the additional advantage that they optimize flow.

The sealing seat of fuel injector 1 has a customary design, with valve-closure member 4 constructed on valve needle 3 and passing through swirl disk 34. In this manner, swirl disk 34 at the same time forms a valve needle guide in the region of the sealing seat. Valve-closure member 4 cooperates with valve-seat surface 6, which is constructed on valve-seat member 5. A swirl chamber 40 is thus formed on the inflow side of valve-seat surface 6 which is delimited by valve-seat member 5, valve-closure member 4 and swirl disk 34.

Fuel channels 37 formed by overlapping fuel passages 35 open into swirl chamber 40. The volume of swirl chamber 40 is optimally dimensioned in such a way that it is possible to form a stable turbulent flow which is homogeneous in the circumferential direction, with the dead volume kept as low as possible.

When fuel injector 1 is actuated, fuel flows through fuel channels 37 into swirl chamber 40 and, after the fuel lifts up valve-closure member 4 from valve-seat surface 6, the fuel leaves the swirl chamber via spray-discharge orifice 7. Turbulence is thus maintained, so that the fuel is injected in a spiral fashion into the combustion chamber (not shown) of an internal combustion engine.

FIG. 2B represents a top view of swirl disk 34 from the first embodiment of fuel injector 1 according to the present invention shown in FIG. 2A, in the direction of outflow.

The view shows the inflow side of first swirl element 36a, whose four fuel passages 35a, which in the present embodiment are square with rounded corners, are represented by a solid line. Fuel passages 35b of second swirl element 36b on the injection side are partially visible through fuel passages 35a of first swirl element 36a. In the visible areas, fuel passages 35b are again represented by solid lines, and concealed areas are represented by dotted lines. Fuel passages 35c formed in subsequent third swirl element 36c are barely visible through fuel passages 35a of swirl element 36a, since fuel passages 35a through 35c each overlap one another by approximately 50%. As a result, fuel passages 35d of fourth swirl element 36d are no longer visible through fuel passages 35a of first swirl element 36a.

Since swirl disk 34 is also used as a cardanic valve needle guide 46 for valve-closure member 4, swirl elements 36 are designed as a ring having a central cavity 48 in which valve-closure member 4 is guided. Cardanic valve needle guide 46 is used to compensate for guide errors in the inflow-side region of fuel injector 1 resulting from inaccuracies in manufacturing, since valve-closure member 4 is virtually spherical in shape and thus has multiple degrees of freedom in which to compensate for displacements. Valve needle 3 may be manufactured in two parts, for example, using a sphere for valve-closure member 4 and a shaft for valve needle 3. However, one-part constructions such as in the present embodiment may also be advantageously used when an appropriately designed valve-closure member 4 is provided.

FIG. 3A shows, in the same representation as FIG. 2A, a second embodiment of fuel injector 1 designed according to the present invention. Corresponding parts are provided with the same reference numbers.

In contrast to the embodiment of a fuel injector 1 according to the present invention illustrated in FIG. 2A, in the present embodiment swirl disk 36 is situated downstream from the sealing seat. In addition, fuel injector 1 is designed as a diagonally injecting fuel injector 1, which enables better adjustment of an injection angle γ than does an inclination of spray-discharge orifice 7. A longitudinal axis 44 of an injection unit 49 accommodating swirl disk 34 is thus inclined with respect to longitudinal axis 45 of fuel injector 1. However, longitudinal axis 44 of injection unit 49 may also coincide with longitudinal axis 45 of fuel injector 1, it being necessary once again to incline spray-discharge orifice 7, as in the embodiment represented in FIG. 2A, to achieve injection angle γ.

In the present second embodiment, valve-seat member 5 likewise has a cardanic valve needle guide 46 to counteract tilting and off- center displacements of valve needle 3 using a spherical guide. For conducting fuel, valve-closure member 4 is provided with at least one ground face 47 in the region of cardanic valve needle guide 46.

On the outflow side of the sealing seat, which has the same design as in the first embodiment, valve-seat member 5 has a preferably cylindrical cavity 43 in which a plug-in unit 41 may be inserted. Plug-in unit 41 likewise has a cylindrical shape. Swirl disk 34, which in the present embodiment has three swirl elements 36, is situated in a cavity 42 of plug-in unit 41. Downstream from swirl disk 34 is constructed swirl chamber 40 into which fuel channels 37, which are formed from overlapping fuel passages 35 of swirl elements 36, open. Swirl chamber 40 merges into spray-discharge orifice 7.

In the present embodiment, swirl disk 34 has three swirl elements 36a through 36c, each swirl element 36 having four fuel passages 35. By arranging swirl disk 34 on the outflow side of the sealing seat, it is not absolutely necessary to weld swirl elements 36 to one another or to plug-in unit 41, since swirl elements 36 are always acted upon by the fuel pressure in the downstream direction and therefore are not displaceable in the direction opposite the direction of flow The modular design of fuel injector 1 may thus be further simplified. Nevertheless, it is advantageous to adhere or weld swirl elements 36 to one another, or to produce swirl disk 34 in one piece by electrodeposition, so that after assembly it is not possible to change the position of fuel passages 35 with respect to one another, which displacement otherwise would limit the turbulence effect and the fuel flow rate.

When fuel injector 1 is actuated, the fuel flows around valve-closure member 4 via ground face 47, and turbulence is imparted on the fuel as it passes the sealing seat in swirl disk 34. The fuel thus moves in a spiral fashion through spray-discharge orifice 7 into the combustion chamber (not shown).

FIG. 3B shows a top view of the swirl disk of the second embodiment of fuel injector 1 according to the present invention illustrated in FIG. 3A, in the direction of outflow.

Analogous to FIG. 2B, the view shows inflow-side first swirl element 36a, whose square fuel passages 35a with rounded corners are represented by a solid line. Fuel passages 35b of second swirl element 36b next closest to the injection side are partially visible through fuel passages 35a of first swirl element 36a. In the visible areas, fuel passages 35b are again represented by solid lines, and concealed areas are represented by dotted lines. Fuel passages 35c formed in subsequent third swirl element 36c are visible through fuel passages 35a of swirl element 36a, but only in a very small area, since fuel passages 35a through 35c each overlap one another by approximately 50%. Since valve-closure member 4 does not pass through swirl elements 36 in the present embodiment, the swirl elements have a disk-shaped design without a central cavity 48.

The number of fuel passages 35 per swirl element 36 is limited mainly by the size of their cross section; that is, the larger the number of fuel passages 35 per swirl element 36, the smaller the diameter of fuel passages 35 must be to assure a constant fuel flow rate. For stability reasons, individual fuel passages 35 of each swirl element 36 should be separated from one another by a distance equal to the diameter of fuel passages 35.

The present invention is not limited to the represented embodiments, and is also applicable, for example, to fuel injectors 1 having a greater number of swirl elements 36 or having larger or smaller fuel passages 35 in any shape or number, as well as to any design of fuel injector 1.

What is claimed is:

1. A fuel injector (1), in particular for direct injection of fuel into a combustion chamber of an internal combustion engine, having a valve-closure member (4) which, together with a valve-seat surface (6) formed on a valve-seat member (5), forms a sealing seat, and having a swirl disk (34) having fuel passages (35), wherein the swirl disk (34) is constructed from a plurality of swirl elements (36), each of the swirl elements (36) having the same number of fuel passages (35), and the swirl elements (36) being offset with respect to one another in such a way that the fuel passages (35) at least partially overlap.

2. The fuel injector according to claim 1, wherein the overlapping fuel passages (35) of the individual swirl elements (36) together form fuel channels (37) which pass through the swirl disk (34) from a side (38) on the inflow side to a side (39) on the outflow side.

3. The fuel injector according to claim 1 or 2, wherein the swirl disk (34) is provided with at least two swirl elements (36).

4. The fuel injector according to one of claims 1 through 3, wherein the fuel passages (35) have a square, rectangular, or rounded cross section.

5. The fuel injector according to claim 4, wherein the fuel passages (35) are each rotated in the same direction with respect to one another.

6. The fuel injector according to one of claims 1 through 5, wherein the swirl disk (34) is situated on the inflow side of the sealing seat.

7. The fuel injector according to claim 6, wherein the valve-closure member (4) passes through the swirl disk (34) and is guided by same.

8. The fuel injector according to one of claims 1 through 7, wherein a swirl chamber (40) is formed in the valve-seat member (5) on the outflow side of the swirl disk (34), and the fuel channels (37) formed by the overlapping fuel passages (35) open into the swirl chamber.

9. The fuel injector according to one of claims 1 through 8, wherein the swirl elements (36) of the swirl disk (34) are welded to one another and to the valve-seat member (5).

10. The fuel injector according to one of claims 1 through 5, wherein the swirl disk (34) is situated on the outflow side of the sealing seat.

11. The fuel injector according to claim 10, wherein the swirl disk (34) is situated in a cavity (42) of a plug-in unit (41) which is insertable into an outflow-side cavity (43) of the valve-seat member (5).

12. The fuel injector according to claim 11, wherein a longitudinal axis (44) of the plug-in unit (41) is inclined with respect to a longitudinal axis (45) of the fuel injector (1).

13. The fuel injector according to claim 11 or 12, wherein a swirl chamber (40) into which the fuel channels (37) formed from the overlapping fuel passages (35) open is formed between the swirl disk (34) and a spray-discharge orifice (7) which is constructed in the plug-in unit (41).
